(19) United States
(12) Patent Application Publication
(10) Pub. No.: US 2024/0181466 A1
(43) Pub. Date: Jun. 6, 2024

(54) DEVICE AND METHOD FOR INTRODUCING INCOHERENT MATERIAL INTO A MACHINE

(71) Applicant: RAF - Ricambi Attrezzature Per La Frantumazione S.p.a., Montesilvano (IT)

(72) Inventors: Eddy PONTELLI, Tricesimo (IT); Enrico VENEROSO, Udine (IT); Guido ANDREUSSI, Tavagnacco (IT); Olivia ANDREUSSI, Cesena (IT)

(21) Appl. No.: 18/562,150

(22) PCT Filed: May 27, 2022
(86) PCT No.: PCT/IT2022/050148

§ 371 Date: Nov. 17, 2023

(30) Foreign Application Priority Data
May 27, 2021 (IT) 102021000013820

(51) Int. Cl. B02C 13/09; B02C 13/286

(52) U.S. Cl. CPC B02C 13/09; B02C 13/286; B02C 2013/28672

(57) ABSTRACT

Device for introducing incoherent material into a machine for processing incoherent material including an external body which is configured to be passed through by an incoherent material and which defines inside it a passage channel having an inlet aperture and an outlet aperture. The device also includes mobile deviation device pivoted to the external body and configured to selectively modify the cross-section of the outlet aperture.

### FIELD OF THE INVENTION

The present invention concerns a device and a method for introducing incoherent material into a machine for treating incoherent material.

The invention is applied in the field of fragmentation, or crushing, of incoherent inert material by means of crushing mills, advantageously of the reversible type.

### BACKGROUND OF THE INVENTION

It is known to treat incoherent material, for recycling purposes, using suitable machines equipped with rotating apparatuses.

An example of such processes is the crushing, or fragmentation, of incoherent inert material carried out using crushing mills 500 of the reversible type (FIG. 1).

Normally, the incoherent material to be crushed is fed to a crusher mill by a feed unit 516.

The feed unit 516 generally comprises a loading hopper with which a conveyor is associated for the metered transfer of the material to be crushed to a tubular conveyor 410, known in the sector as the “loading mouth”.

The tubular conveyor 410 is formed by a plurality of fixed walls 412 and has an inlet end 413, communicating with the motorized conveyor, and an outlet end 414 from which the material to be crushed exits.

The crushing mill 500 comprises an external structure 501 which defines a crushing chamber 503 having an aperture 507 for the introduction of the material positioned in its upper portion and communicating with the outlet end 414 of the tubular conveyor 410. Moreover, a crushing rotor 510 is rotatably mounted inside the crushing chamber 503 and has, on its periphery, a plurality of radially projecting hammers 515.

The hammers 515 receive the material to be crushed as it falls, and throw it against the walls of the crushing chamber, which is lined internally by shaped elements 506 having a profile protruding toward the inside of the crushing chamber 503.

In order to exploit the entire surface of the internal walls of the crushing chamber 503, it is known that the crushing rotor 510 can first rotate in a clockwise direction and, after one work cycle, also in a counterclockwise direction, or vice versa. Therefore, the introduction aperture 507 of the crushing chamber 503 is advantageously centered with respect to the axis of rotation N of the rotor.

This known solution, although appreciated, has some disadvantages in that the material to be crushed introduced centrally with respect to the axis of rotation of the rotor (FIG. 1) also impacts on the upper portion of the hammers, causing abnormal, early and unpredictable wear of the hammers themselves and of the surfaces of the shaped elements of the crushing chamber.

Furthermore, this known solution causes the introduction of an excessive amount of material inside the crushing chamber, with the consequent increase in the demand for electric energy for the rotation of the crushing rotor. In addition, the excessive introduction of material hinders the correct functioning of the hammers, which are unable to throw all the material introduced against the walls of the crushing chamber. This means that a substantial portion of the material introduced is not crushed when it exits the crushing mill.

It also derives from this that the overall productivity of the crushing mill is not uniform and is unpredictable over time.

Document GB 1570 061 A is also known, which describes a crushing mill having an inlet aperture located laterally with respect to the axis of rotation and downstream of which mobile lamellar bodies are disposed to allow to vary the quantity of material entering into the mill only as a function the type of material to be introduced.

Document EP 1 322 423 A1 is also known, which describes a crushing mill having an inlet aperture with which a rotating device is associated with the function of introducing the material into the mill in small discontinuous batches and accelerating it to increase the energy of the impact with the hammers. This solution increases the energy of the impact of the material and the hammers without reducing their wear.

Finally, document EP 3 325 164 A1 is also known, which describes a crushing mill having an inlet aperture with which a rotating device is associated with the function of disposing the material to be crushed in a prechamber having a chute on which the material to be crushed slides until it reaches the hammers. This solution is used to obtain a continuous feed of the material to be crushed toward the hammers and to eliminate the risk of the crushed material coming out.

However, this solution does not reduce the wear on the hammers. There is therefore a need to perfect a device and method for introducing incoherent material into a machine for treating incoherent material, which can overcome at least one of the disadvantages of the state of the art.

In particular, one purpose of the present invention is to allow to introduce incoherent material into a machine in order to reduce wear on the hammers and on the internal lining of the crushing chamber.

Another purpose of the present invention is to increase the hourly productivity of the machine and make it more constant over time.

Another purpose of the present invention is to reduce the quantity of electric energy necessary to power the machine itself.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, a device according to the present invention, for introducing incoherent material into a machine for processing incoherent material, comprises an external body which defines inside it a passage channel configured to be passed through by an incoherent material and having an inlet aperture and an outlet aperture.

In accordance with one aspect of the present invention, the device also comprises deviation means mobile with respect to the external body, associated with the latter and configured to selectively modify the cross-section of the outlet aperture.

Doing so achieves the advantage of being able to selectively direct the material to be crushed toward different and desired zones of the crushing chamber.

In accordance with another aspect of the present invention, the deviation means are configured to assume a first inactive configuration, in which the cross-section of the outlet aperture is maximum, and its center is disposed in a central position; and at least a first operating configuration in which the center of the cross-section of the outlet aperture is disposed laterally with respect to the central position.

In accordance with another aspect of the present invention, the external body comprises a plurality of fixed walls and the deviation means comprise at least a first mobile wall pivoted at one end thereof to the external body in order to rotate about a first axis, and at least a second mobile wall, opposite the first mobile wall, and pivoted at one end thereof to the external body in order to rotate about a second axis.

In accordance with another aspect of the present invention, the first mobile wall has a free end which defines a first side of the perimeter of the cross-section of the outlet aperture, and the second mobile wall has a free end which defines a second side of the perimeter of the cross-section of the outlet aperture.

In accordance with another aspect of the present invention, the first mobile wall is configured to selectively assume a first inactive position in which it is aligned with at least one of the fixed walls, and a second work position in which it is inclined toward the inside of the external body; in turn, the second mobile wall is configured to selectively assume a first inactive position in which it is aligned with at least one other of the fixed walls, and a second work position in which it is inclined toward the inside of the external body.

In accordance with another aspect of the present invention, the deviation means can assume both a first operating configuration in which the first mobile wall is in the second work position and the second mobile wall is in the first inactive position, and also a second operating configuration in which the first mobile wall is in the first inactive position and the second mobile wall is in the second work position.

In accordance with another aspect of the present invention, a unit for processing incoherent material comprises a machine for processing incoherent material with which a device according to the present invention is operatively associated.

In accordance with another aspect of the present invention, the machine comprises an external structure having an introduction aperture, and a crushing rotor is disposed inside the external structure in order to rotate with respect to the latter about an axis of rotation, and the outlet aperture of the device is disposed aligned and communicating with the introduction aperture.

Preferably, the outlet aperture of the device is overlapping with the axis of rotation in a vertical direction. In particular, the outlet aperture of the device is vertically aligned with the axis of rotation.

In accordance with another aspect of the present invention, a method for introducing incoherent material into a machine for processing incoherent material comprises the following steps:
making a crushing rotor, disposed inside a crushing chamber, rotate about a horizontal axis of rotation;
introducing a material to be crushed into the crushing chamber, directing it mainly toward the zone of the latter in which the crushing rotor completes a semi-circumference in an upward direction.

In accordance with another aspect of the present invention, the method also comprises the following steps:
reversing the direction of rotation of the crushing rotor;
directing the material mainly toward a new zone of the crushing chamber in which the crushing rotor completes a semi-circumference in an upward direction.

In accordance with another aspect of the present invention, in the introduction step, the material is directed by means of a device comprising an external body which defines inside it a passage channel for the material and which has an inlet aperture and an outlet aperture which is communicating with the crushing chamber, the device also comprising deviation means mobile with respect to the external body, associated with the latter and configured to selectively modify the cross-section of the outlet aperture in order to direct the material exiting from the latter mainly toward the zone of the crushing chamber in which the crushing rotor completes a semi-circumference in an upward direction.

### BRIEF DESCRIPTION OF THE DRAWINGS

These and other aspects, characteristics and advantages of the present invention will become apparent from the following description of an embodiment, given as a non-restrictive example with reference to the attached drawings wherein:

FIG. 1 is a front section of a device for introducing incoherent material into a crushing mill, according to the state of the art;

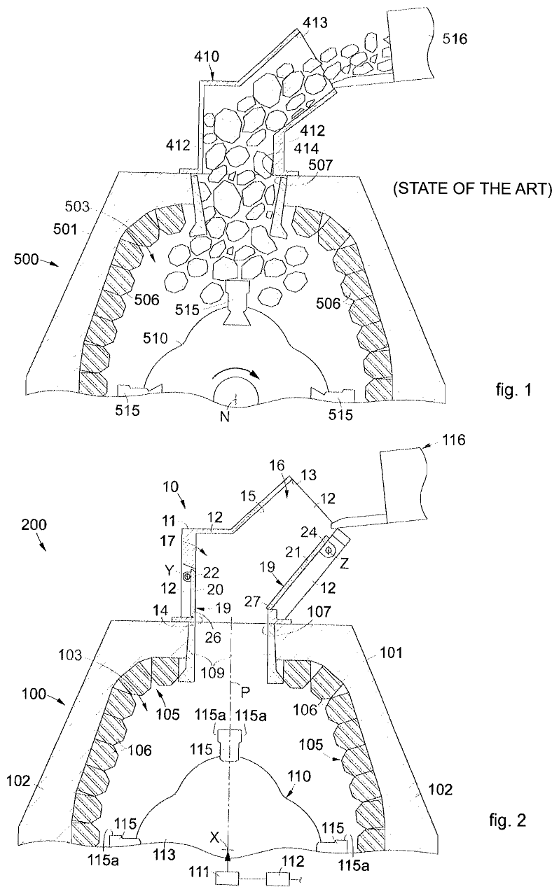

FIGS. 2, 3 and 4 are front sections of a device according to the present invention, associated with a generic machine for processing incoherent material, in different operating configurations;

FIGS. 5, 6 and 7 are bottom views of a portion of the device of FIGS. 2, 3 and 4, in the corresponding operating configurations.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF AN EMBODIMENT OF THE PRESENT INVENTION

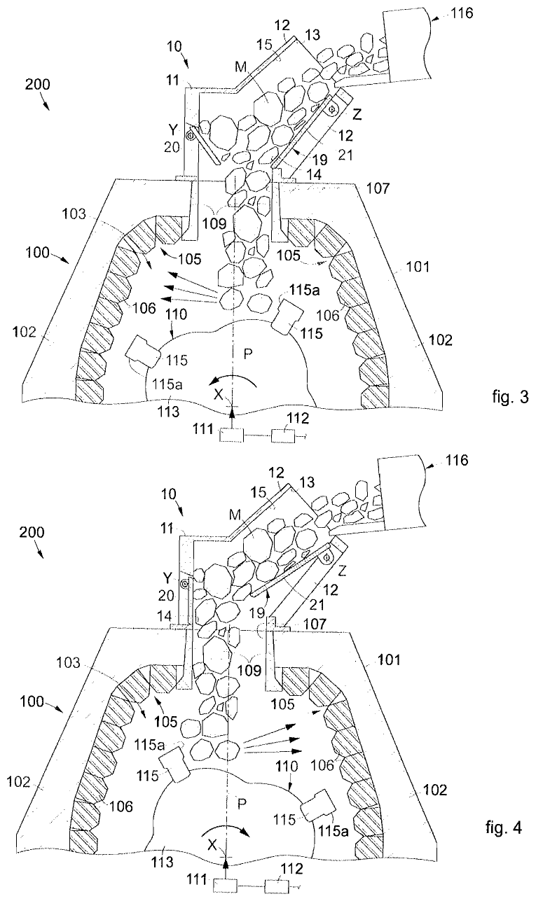

With reference to FIG. 2, a device 10 for introducing incoherent material into a machine for processing incoherent material, according to the present invention, is suitable to be associated with a machine 100 for processing incoherent material.

The incoherent material M can be stone, bricks, cement and more, and the processing referred to provides to crush the material M in order to reduce its granulometry, for example for recycling purposes.

In general terms, the machine 100 comprises a fixed and box-shaped external structure 101 having a plurality of walls 102 which define between them a crushing chamber 103.

The crushing chamber 103 comprises inside it a lining 105 consisting of a plurality of impact elements 106 which are configured to receive the material M to be crushed.

The impact elements 106 are conventionally disposed adjacent to each other in order to form a wall, or “armor”, having a profile defined by a portion of the external surface of each impact element 106.

In the upper portion of the external structure 101 there is disposed an introduction aperture 107, and in correspondence therewith there are disposed two conveying plates 109 converging toward the inside of the crushing chamber 103.

A crushing rotor 110 is mounted inside the crushing chamber 103 in a manner rotatable with respect to the external structure 101 about an axis of rotation X, advantageously horizontal. The crushing rotor 110 can be selectively made to rotate, by means of a first electric motor 111 commanded by a central management unit 112, for example of the programmable type.

The crushing rotor 110 comprises a central body 113 connected to the first electric motor 111, directly or by means of mechanical transmission means of a known type, and one or more launching elements 115, or hammers, each having a lateral impact surface 115a, are disposed on its periphery and projecting in a radial direction with respect to the axis of rotation X.

The launching elements 115 are configured to collide, with their lateral impact surface 115a, against the material M introduced into the crushing chamber 103 in order to launch it against the internal lining 105 thereof. The impact of the material M against the internal lining 105 of the crushing chamber 103 is such as to crush it and, consequently, reduce its granulometry.

The distance between the launching elements 115 and the lining 105 of the crushing chamber 103 is chosen as a function of the type of incoherent material M fed, and/or according to the characteristics of the finished product to be obtained.

The introduction aperture 107 is centered with respect to the axis of rotation X, that is, a vertical plane P comprising the axis of rotation X is passing through the center of the introduction aperture 107.

Feed means 116 of any known type whatsoever, not described in detail, are configured to transfer the material M to be crushed toward the machine 100; the feed means 116 can comprise, for example, a belt or slat conveyor, a bucket conveyor or a mobile bed conveyor, or a vibrating channel.

In the example described here, the device 10 of the present invention is located downstream of the feed means 116 and upstream of the introduction aperture 107 of the crushing chamber 103, and it is configured to introduce into the latter the material M to be crushed that is transferred by the feed means 116.

The device 10 comprises an external body 11 with a box-like or tubular shape, consisting of a plurality of fixed walls 12 and having an inlet aperture 13 and an outlet aperture 14 for the material M.

In particular, the external body 11 defines inside it a passage channel 15 configured to be passed through by the material M to be crushed.

During use, the device 10 is disposed on the external structure 101 of the machine 100 so as to align and put in communication its outlet aperture 14 with the introduction aperture 107 of the crushing chamber 103.

In this way, the outlet aperture 14 is overlapping with the axis of rotation X in the vertical direction. In particular, the outlet aperture 14 is vertically aligned with the axis of rotation X.

In the example provided here, the passage channel 15 has a first segment 16 disposed in such a way as to facilitate the collection of the material M transferred by the feed means 116, and a second segment 17, angled with respect to the first segment 16, disposed substantially vertically in order to facilitate the fall of the material M into the crushing chamber 103.

According to one aspect of the present invention, the device 10 comprises deviation means 19, mobile with respect to the external body 11 and associated with the latter, which are configured to selectively modify the cross-section S of the outlet aperture 14.

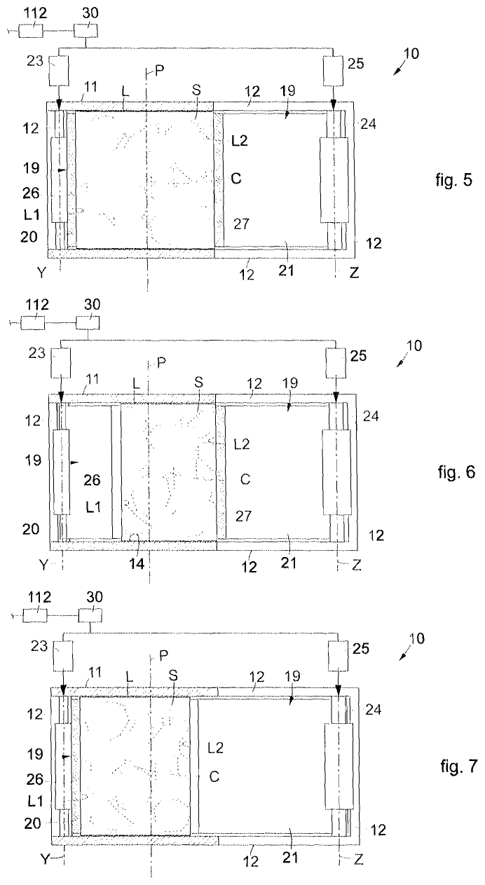

In particular, the deviation means 19 are configured to assume at least a first inactive configuration (FIGS. 2 and 5) in which the cross-section S of the outlet aperture 14 is maximum and its center C is disposed in a central position, and at least a first operating configuration (FIGS. 3 and 6 and FIGS. 4 and 7) in which the center C of the cross-section S of the outlet aperture 14 is disposed laterally with respect to the central position.

Preferably, in the inactive position, the center C of the cross-section S of the outlet aperture 14 lies on a vertical plane also containing the axis of rotation X. For example, in this case the center C lies on the plane P.

This allows to direct the material M introduced into the crushing chamber 103 as a function of the position assumed by the deviation means 19, as will be explained in detail below.

In the example provided here, the mobile deviation means 19 comprise a first mobile wall 20 and a second mobile wall 21, both rectangular in shape, and which in cooperation with the fixed walls 12 delimit the passage channel 15 (FIG. 2).

The first mobile wall 20 is disposed in a position opposite to and facing the second mobile wall 21 with respect to the plane P.

The first mobile wall 20 is pivoted at one end 22 thereof to the support body 11 in order to selectively rotate about a first axis Y from a first inactive position, in which it is aligned with the adjacent fixed walls 12, to a second work position, in which it is inclined toward the inside of the external body 11 (FIG. 3). The rotation of the first mobile wall 20 is commanded by a first actuator 23 (FIG. 6), for example a hydraulic piston, which is commanded by a control unit 30, for example of the programmable type and configured to communicate with the central management unit 112.

Similarly, the second mobile wall 21 is pivoted at one end 24 thereof to the support body 11 in order to selectively rotate about a second axis Z from a first inactive position (FIG. 2), in which it is aligned with the adjacent fixed walls 12, to a second work position, in which it is inclined toward the inside of the external body 11 (FIG. 4). The rotation of the second mobile wall 21 is commanded by a second actuator 25 (FIG. 7), for example a hydraulic piston, which is also commanded by the control unit 30.

In the first inactive configuration of the deviation means 19, both the mobile walls 20, 21 are in the inactive position (FIGS. 2 and 5).

In the first operating configuration of the deviation means 19, the first mobile wall 20 is in the work position and the second mobile wall 21 is in the inactive position (FIGS. 3 and 6). On the other hand, in the second operating configuration of the deviation means 19, the first mobile wall 20 is in the inactive position and the second mobile wall 21 is in the work position (FIGS. 4 and 7).

The first mobile wall 20 has a free end 26 which defines a first side L1 of the perimeter L of the cross-section S, and the second mobile wall 21 also has a free end 27 which defines a second side L2 of the perimeter L of the cross-section S (FIGS. from 5 to 7).

The other two sides of the perimeter L are defined by two fixed walls 12 disposed orthogonal with respect to the first mobile wall 20 and to the second mobile wall 21.

In the inactive configuration as above, the first mobile wall 20 is disposed vertically and its free end 26 is in correspondence with one side of the introduction aperture 107. Furthermore, the second mobile wall 21 is disposed inclined with respect to the first mobile wall 20 and its free end 27 is in correspondence with a second side of the introduction aperture 107.

Instead, referring to FIGS. 3 and 6, which show the device 10 in the first operating configuration, the first mobile wall 20 is inclined toward the inside of the external body 11 and the first side L1 is displaced laterally (toward the right in FIG. 6) with respect to the previous inactive configuration. Therefore, a greater portion of the cross-section S is disposed to the right with respect to the plane P, and a smaller portion of the cross-section S is disposed to the left with respect to the plane P. It follows that the center C of the cross-section S will be disposed to the right with respect to the plane P.

This allows to introduce the material M to be crushed into the crushing chamber 103 directing it mainly toward the right portion of the crushing rotor 110, in such a way that it optimally impacts the lateral impact surfaces 115a of the launching elements 115, limiting their wear. In fact, as can be seen in FIG. 3, in this operating configuration, the crushing rotor 110 rotates in a counterclockwise direction so that the material M optimally impacts the lateral impact surfaces 115a of the launching elements 115 which complete a semi-circumference in an upward direction.

In addition, referring to FIGS. 4 and 7, which show the device 10 in the second operating configuration, the first mobile wall 20 is in the inactive position and the second mobile wall 21 is inclined toward the inside of the external body 11, so that the second side L2 is displaced laterally (to the left in FIG. 7) with respect to the previous inactive configuration. Therefore, a larger portion of the cross-section S is disposed to the left with respect to the plane P and a smaller portion of the cross-section S is disposed to the right with respect to the plane P. It follows that the center C of the cross-section S will be disposed to the left with respect to the plane P.

Therefore, in this configuration, the material M is introduced mainly toward the left portion of the crushing rotor 110 which, in this operating configuration, rotates in a clockwise direction, so that, also in this case, the material M optimally impacts the lateral impact surfaces 115a of the launching elements 115 which complete a semi-circumference in an upward direction.

This allows to reduce the wear of the launching elements 115 and to optimize the quantity of material M to be crushed that is introduced into the machine, reducing the energy required for its operation and the quantity of material that is not crushed.

A person of skill in the art will easily understand that the shape and disposition of the first mobile wall 20 and of the second mobile wall 21 can vary with respect to the example provided here, without departing from the scope of the present invention. For example, both mobile walls 20, 21, in the inactive position, can be disposed vertically, or inclined with respect to each other, and their shape can be different from the rectangular one, for example they can be curved or shaped so as to define any desired lateral profile.

It should also be noted that the device 10 of the present invention allows to introduce the material M into the crushing chamber 103 in a substantially continuous manner.

In accordance with another aspect of the present invention, a unit 200 for processing incoherent material comprises any machine 100 whatsoever for processing incoherent material, even of a type known per se, with which there is operatively associated a device 10 according to the present invention.

The operation of the unit 200 for processing incoherent material, which corresponds to a method for introducing incoherent material into a machine in accordance with the present invention, is as follows.

The central management unit 112 drives the feed means 116 so that the material M to be crushed is transported toward the device 10 which is associated with the machine 100 (FIG. 2) and is in the inactive configuration.

Preferably, the feed of the material M to be crushed toward the device 10, and therefore into the crushing chamber 103, is substantially continuous.

The central management unit 112 also drives the first electric motor 111, causing the rotation of the crushing rotor 110, and it communicates the direction of the rotation of the crushing rotor 110 to the control unit 30.

Based on the direction of the rotation of the crushing rotor 110, the control unit 30 drives the first actuator 23 or the second actuator 25 in order to take the deviation means 19 into their first operating configuration or into their second operating configuration.

In particular, the control unit 30 will take the deviation means 19 into the operating configuration whereby the material M introduced into the crushing chamber 103 is directed mainly toward the zone of the latter in which the launching elements 115 of the crushing rotor 110 complete a semi-circumference in an upward direction.

For example, with reference to FIG. 3, the central management unit 112 drives the first electric motor 111 causing the rotation of the crushing rotor 110 in an anti-clockwise direction, and communicates it to the control unit 30 which drives the first actuator 23 in order to take the deviation means 19 into the first operating configuration.

Subsequently, with reference to FIG. 4, the central management unit 112 commands the first electric motor 111 to slow down and reverse the direction of rotation, causing the crushing rotor 110 to rotate in a clockwise direction. This inversion of the direction of rotation of the crushing rotor 110 is communicated to the control unit 30 which will drive the first actuator 23 and the second actuator 25 in order to take the deviation means 19 into the second operating configuration.

It is clear that modifications and/or additions of parts or steps may be made to the device 10 and to the method as described heretofore, without departing from the field and scope of the present invention.

It is also clear that, although the present invention has been described with reference to some specific examples, a person of skill in the art shall certainly be able to achieve many other equivalent forms of device, or method, for introducing incoherent material into a machine for processing incoherent material having the characteristics as set forth in the claims and hence all coming within the field of protection defined thereby.

In the following claims, the sole purpose of the references in brackets is to facilitate reading and they must not be considered as restrictive factors with regard to the field of protection defined by the claims.

1.-13. (canceled)

14. A device (10) for introducing incoherent material into a machine for processing incoherent material, said device (10) comprising an external body (11) which defines inside it a passage channel (15) configured to be passed through by an incoherent material (M) and having an inlet aperture (13) and an outlet aperture (14), said device (10) also comprising deviation means (19) mobile with respect to said external body (11), which are associated with the latter and are configured to selectively modify the cross-section (S) of said outlet aperture (14), wherein said deviation means (19) comprise both a first mobile wall (20) pivoted at one end (22) thereof to said external body (11) in order to rotate about a first axis (Y), and also a second mobile wall (21), opposite said first mobile wall (20), and pivoted at one end (24) thereof to said external body (11) in order to rotate about a second axis (Z), wherein said external body (11) comprises a plurality of fixed walls (12), and wherein said deviation means (19) have a first operating configuration in which said first mobile wall (20) is in a work position inclined toward the inside of said external body (11) and the second mobile wall (21) is in an inactive position aligned with adjacent fixed walls (12), and a second operating configuration in which said first mobile wall (20) is in an inactive position aligned with adjacent fixed walls (12) and the second mobile wall (21) is in a work position inclined toward the inside of said external body (11).

15. The device (10) as in claim 14, wherein said deviation means (19) are configured to assume a first inactive configuration in which the center (C) of said cross-section (S) is disposed in a first position; and at least a first operating configuration in which the center (C) of said cross-section (S) is disposed laterally with respect to said first position.

16. The device (10) as in claim 14, wherein said first mobile wall (20) has a free end (26) that defines a first side (L1) of the perimeter (L) of said cross-section (S), wherein said second mobile wall (21) has a free end (27) that defines a second side (L2) of said perimeter (L) of said cross-section (S).

17. A unit (200) for treating incoherent material (M) comprising a machine (100) for treating incoherent material (M) with which there is associated a device (10) as in claim 14.

18. The unit (200) for treating incoherent material (M) as in claim 17 and wherein said machine (100) comprises an external structure (101) having an introduction aperture (107), and a crushing rotor (110) disposed inside said external structure (101) in order to rotate with respect thereto about a horizontal axis of rotation (X), wherein the outlet aperture (14) of said device (10) is disposed in correspondence with said introduction aperture (107) and aligned therewith.

19. The unit (200) for treating incoherent material (M) as in claim 17, wherein said outlet aperture (14) of said device (10) is overlapping with said axis of rotation (X) in a vertical direction.

20. A method for introducing incoherent material into a machine for treating incoherent material using a device as in claim 14, and comprising:
making a crushing rotor (110), disposed inside a crushing chamber (103), rotate about a horizontal axis of rotation (X);
introducing a material (M) to be crushed into said crushing chamber (103), directing it mainly toward the zone of said crushing chamber (103) in which said crushing rotor (110) completes a semi-circumference in an upward direction.

21. The method as in claim 20, wherein it also comprises the following steps:
reversing the direction of rotation of said crushing rotor (110);
directing said material (M) mainly toward the zone of said crushing chamber (103) in which said crushing rotor (110) completes a semi-circumference in an upward direction.

22. The method as in claim 20, wherein said introduction step, said material (M) is directed by means of a device (10) comprising an external body (11) that defines inside it a passage channel (15) for said material (M) having both an inlet aperture (13) and also an outlet aperture (14) that has a cross-section (S) and is communicating with said crushing chamber (103), said device (10) also comprising deviation means (19) mobile with respect to said external body (11), which are associated with the latter and are configured to selectively modify said cross-section (S) in order to direct said material (M) exiting from the latter mainly toward the zone of said crushing chamber (103) in which said crushing rotor (110) completes a semi-circumference in an upward direction.

23. The method as in claim 20, wherein said material is introduced into said crushing chamber (103) in a substantially continuous manner.
